(19) United States
(12) Patent Application Publication
(10) Pub. No.: US 2022/0349508 A1
(43) Pub. Date: Nov. 3, 2022

(54) Restraint System For Tight Flowline Configurations, And Method of Use Thereof

(71) Applicant: Canyon Rigging Inc., Calgary (CA)

(72) Inventor: Daniel William Harris, Okotoks (CA)

(21) Appl. No.: 17/731,555

(22) Filed: Apr. 28, 2022

Related U.S. Application Data
(60) Provisional application No. 63/183,147, filed on May 3, 2021.

(51) Int. Cl. F16L 55/00; D04C 1/12

(52) U.S. Cl. CPC F16L 55/005; D04C 1/12

(57) ABSTRACT

A restraint net is provided for use in restraining a tight grouping of flowline elements where restraint lines are unusable. The restraint net includes a net body woven of one or more restraining ropes; and a net perimeter comprising one or more restraining ropes, surrounding the net body. The restraint net is configured to cover the tight grouping of flowline elements and being of sufficient tensile strength to restraint movement of the flowline elements in case of a failure or separation of the flowline elements in the tight grouping. A method is also provided of restraining a tight grouping of flowline elements where restraint lines are unusable. The method includes: providing the restraint net as described above; coupling a first point of the net perimeter to any one or more of an anchoring device, an adjacent restraint net or an adjacent restraint line; extending the net body over the tight grouping of flowline elements; and securing one or more further points of the net perimeter to one or more further anchoring devices, one or more further restraint nets, or one or more further adjacent restraint lines. Upon a failure or separation of the flowline elements, the restraining net restrains movement of the flowline elements.

### FIELD

The present disclosure relates to a flowline restraint system and methods of using the system.

### BACKGROUND

Flowlines refer to pipe segments, valves, joints and connections located above ground and used in several industrial applications. They can be formed of rigid members or flexible hose, with a purpose of conducting fluids under pressure from a source location to an output location. As an example, flowlines are often used in the oil and gas industry to connect a surface wellhead to a pump truck or other such equipment. In some circumstances these flowlines are not permanent installments but are rather temporarily connected. This permits assembly of the temporary flowline to a custom length and layout configuration, depending on the location and operational requirements.

Flowlines are frequently used to transport fluids under high pressure. The internal pressure in the flowline can be several thousand pounds per square inch. As such, if a joint between flowline segments were to fail, the results can be catastrophic. Under conditions of high pressure, the energy release resulting from flowline segment separation can cause flowline segments to become projectiles that are ejected at high velocity. This is unsafe and potentially lethal to operators working around flowlines. There is also chance of damage to equipment.

Flowline restraint lines have been developed to secure flowline segments to reduce injuries and death. Restraint lines can be cables or flexible cords in a range of synthetic fiber including polyester, nylon, high modulus polyethylene (HMPE) and other materials, wrapped and tied around flowlines to minimize the movement of flowline elements in the event of a separation. The restraint lines are wrapped around the flowlines and connected to one another in particular configurations that can ensure that the restraint lines will stay connected to the flowline segments and to adjoining restraint lines, in the case of a flowline rupture. An example of such restraint lines and methods of use can be seen in Applicant's granted Canadian patent no. 2,957,167.

While restraint lines work well in many flowline applications, there are commonly flowline systems that are so tightly arranged together that there is no room for wrapping and tying restraint lines. In some cases, the flowlines are made up of cross overs and components with no pipe segments (often called pups) therebetween. In such cases, it is often difficult or even impossible accommodate restraint lines between the flowline sections due to the very limited space. Even when wrapped, it often occurs that restraint lines cannot be applied in such a manner as to ensure they stay wrapped and providing restraint.

A need therefore exists in the art for restraining means that can be used to restrain tight groupings of flowlines. A need further exists for restraining means for tight groupings of flowlines that can be connected to other restraint lines and restraint line systems.

### SUMMARY

Accordingly a restraint net is provided for use in restraining a tight grouping of flowline elements where restraint lines are unusable. The restraint net comprises a net body woven of one or more restraining ropes; and a net perimeter comprising one or more restraining ropes, surrounding the net body. The restraint net is configured to cover the tight grouping of flowline elements and being of sufficient tensile strength to restraint movement of the flowline elements in case of a failure or separation of the flowline elements in the tight grouping.

A method is also provided of restraining a tight grouping of flowline elements where restraint lines are unusable. The method comprises the steps of: providing the restraint net as described above; coupling a first point of the net perimeter to any one or more of an anchoring device, an adjacent restraint net or an adjacent restraint line; extending the net body over the tight grouping of flowline elements; and securing one or more further points of the net perimeter to one or more further anchoring devices, one or more further restraint nets, or one or more further adjacent restraint lines. Upon a failure or separation of the flowline elements, the restraining net restrains movement of the flowline elements.

It is to be understood that other aspects of the present disclosure will become readily apparent to those skilled in the art from the following detailed description, wherein various embodiments of the disclosure are shown and described by way of illustration.

As will be realized, the disclosure is capable of other and different embodiments and its several details are capable of modification in various other respects, all without departing from the spirit and scope of the present disclosure. Accordingly the drawings and detailed description are to be regarded as illustrative in nature and not as restrictive.

### BRIEF DESCRIPTION OF THE DRAWINGS

A further, detailed, description of the disclosure, briefly described above, will follow by reference to the following drawings of specific embodiments of the disclosure. The drawings depict only typical embodiments of the disclosure and are therefore not to be considered limiting of its scope. In the drawings:

FIG. 1 illustrates one embodiment of a restraint net of the present disclosure;

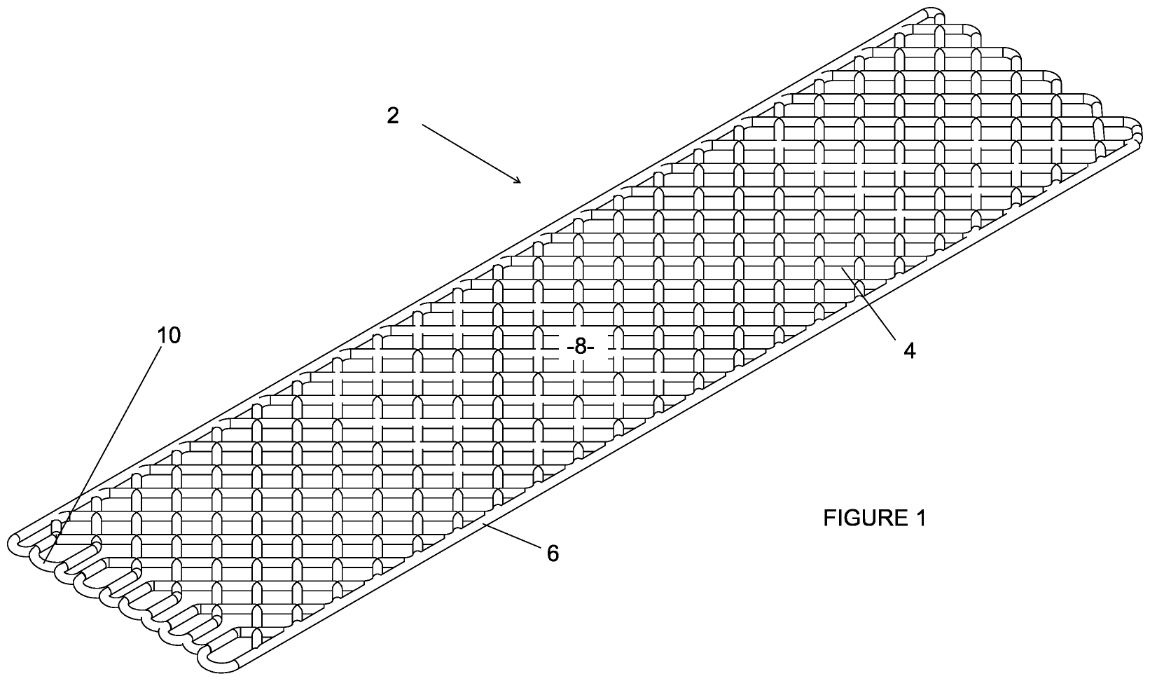

FIG. 2 is a close up view of the restraint net of FIG. 1;

FIG. 3 illustrates an embodiment of a use of a restraint net of the present disclosure;

FIG. 4 illustrates another embodiment of a use of a restraint net of the present disclosure;

FIG. 5 illustrated one embodiment of a restraint net of the present disclosure, made from flat webbing; and

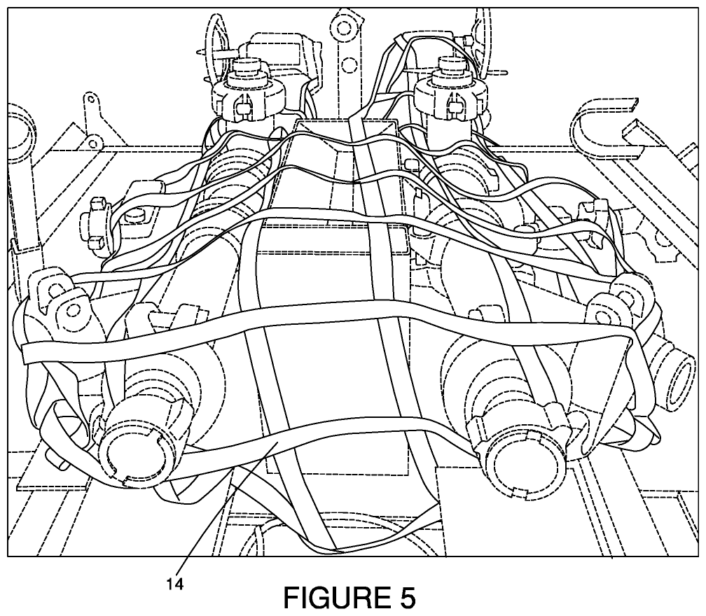

FIG. 6 is a close up view of the restraint net of FIG. 1, showing also a shackle connecting mechanism.

The drawings are not necessarily to scale and in some instances proportions may have been exaggerated in order to more clearly depict certain features.

### DETAILED DESCRIPTION

The description that follows and the embodiments described therein are provided by way of illustration of an example, or examples, of particular embodiments of the principles of various aspects of the present disclosure. These examples are provided for the purposes of explanation, and not of limitation, of those principles and of the disclosure in its various aspects.

With reference to the present Figures, the present disclosure provides a restraint system 100 for restraining flowlines 110 in tight configurations 120 where traditional restraint lines cannot be accommodated.

More particularly the present disclosure relates to a flowline restraint system 100 configured as one or more restraining nets 2. The present restraint net 2 can serve to cover tight groupings of flowline 120. The present restraint net 2 can preferably also be connected to adjacent or nearby restraint lines 130 which may be in use for restraining non-tight groupings of flowlines 110. As such, a combination of the present restraint nets 2 with existing restraint lines 130 can minimize the potential for the flying flowline segments, even in tight groupings 120, should a separation occur.

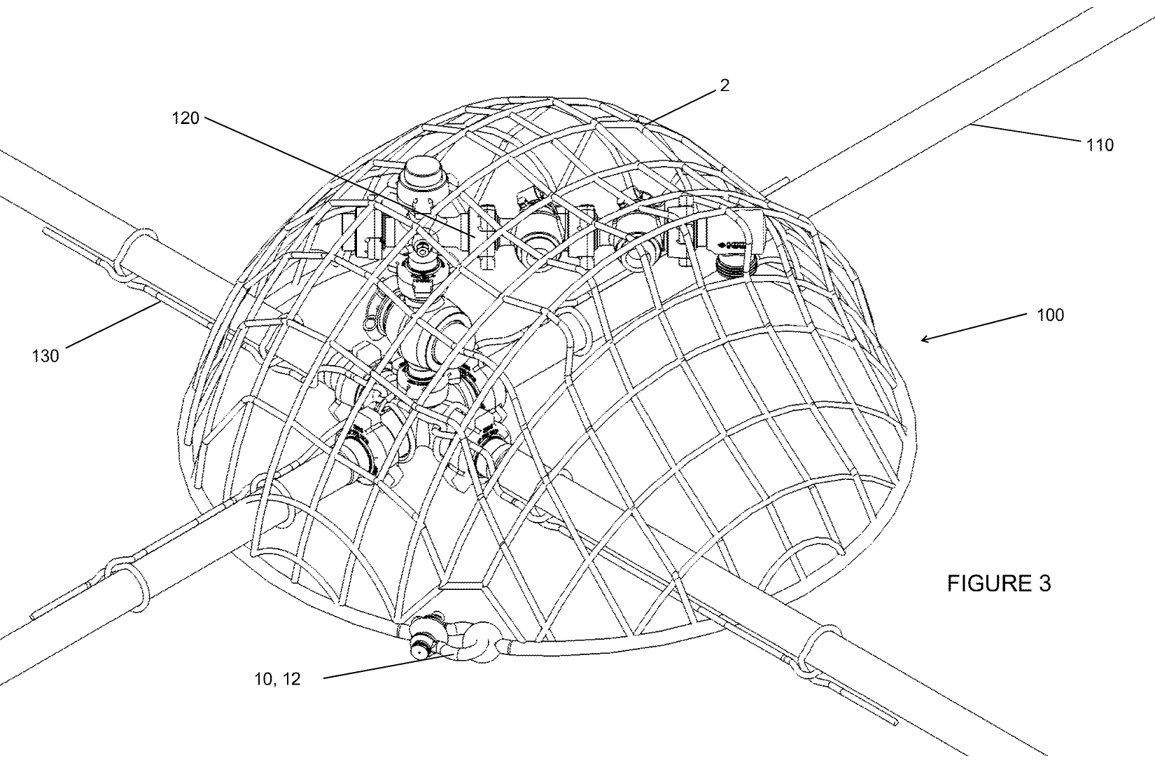

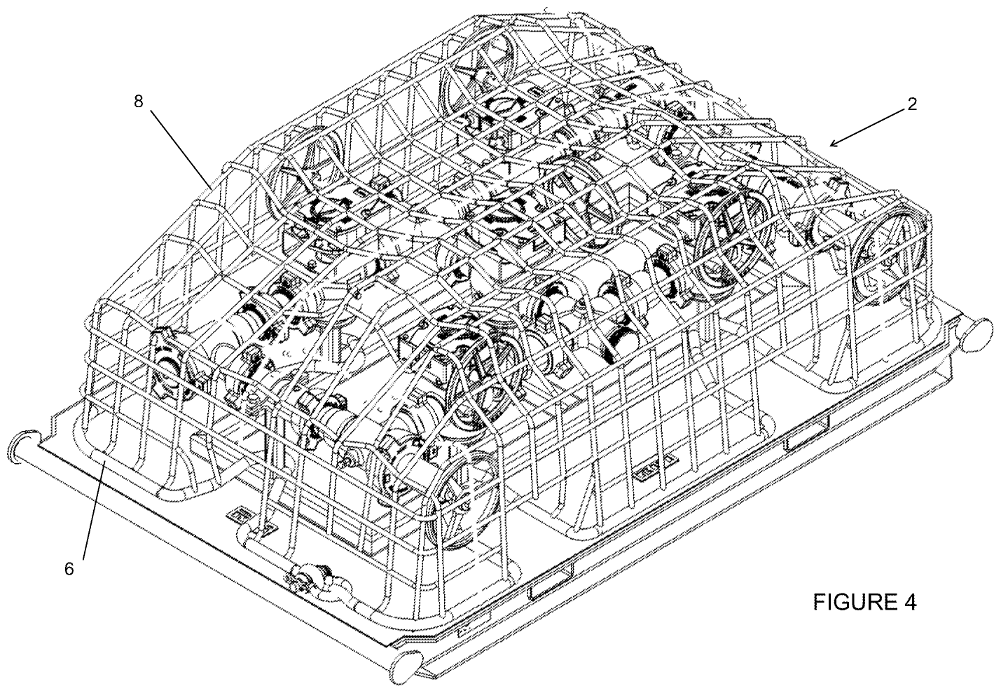

The present restraint net 2 can be draped over the tight grouping of flowlines 120 to thereby restraint their movement in the event of a separation. The present restraint nets 2 can be of different sizes and shapes including rectangular, square, circular, oval or triangular, some examples of which are illustrated in FIGS. 3 and 4. The present restraint nets 2 can also be woven in a flat or non-flat form, such a domed, to better accommodate elements of the tight grouping of flowlines 120. The present restraint net 2 size, shape and form can also be custom made to fit particular tight configurations of flowlines 120.

The present restraint net 2 may be woven from ropes 4 or flat webbing 14 made of any number of materials, including synthetic rope, polyester, nylon, high modulus polyethylene (HMPE) and similar materials to those used to manufacture existing restraint lines. The diameter of the restraint net ropes 4 and the method of weave will be such that the resulting restraint net 2 meets regulations for restraint systems. More preferably, the restraint nets 2 are designed to restrain several thousands of pounds per square inch of potential separation force from the flowlines.

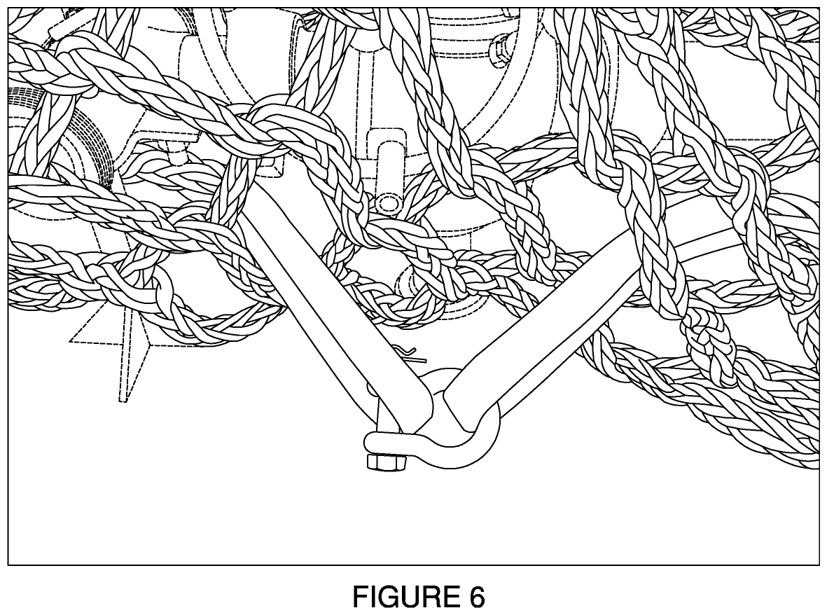

The perimeter 6 of the present restraint net 2 may be formed of rope 4 that is either equal to or thicker than the rope 4 used for a body 8 of the restraint net 2. In a preferred embodiment, the perimeter 8 of the restraint net may also provide mechanisms 10 for connecting the net to adjacent restraint lines used to restrain adjacent flowlines. For example, the restraint net may include hooks, loops, tethers or extra rope along its perimeter, which can be tied to adjacent restraint lines. Alternatively, other, external connecting mechanisms 12 such as shackles or clevises, as illustrated in FIG. 6, can be used to connect restraint nets 2 to themselves or to restraint lines 130 to form a cohesive restraint system 100.

It is possible to connect restraint nets 2 to other restraint nets 2 using similar connecting mechanisms 10,12 to those described above. In this way a larger surface area of tight groupings of flowlines 120 can be covered.

Restraint nets 2 can also be anchored to any anchoring device including to a well head, to a truck, or to a dedicated anchoring mechanism. Restraint nets 2 can also be ‘self-anchoring’ when connected to adjacent restraint lines 130, which restraint lines 130 are run under the tight grouping 120 and then around adjacent flowlines 110. In such cases if the tight grouping 120 separates, then the restraint net 2 can be anchored off of the adjacent restraint line 130, which remains intact.

The weave of the restraint net 2 can be of any format suitable for providing the strength needed to restrain the tight groupings of flowlines 120 in the event of a separation. To prevent flowline elements from slipping through openings in the net body 8 in the event of a separation, preferably the weave of the restraint net 2 is tight enough to ensure that woven ropes 4 of the net body 8 pass over all flowline elements of the tight grouping 120.

The weave structure can include braided, knotted stitched or knotless structures.

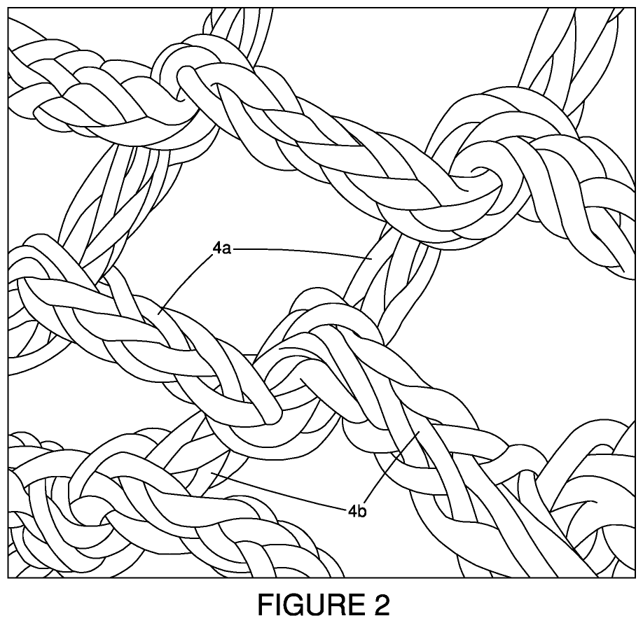

In a further preferred embodiment, a knotless weave structure is used to make up the restraint net 2, as illustrated in FIG. 2. In this embodiment, the rope 4 used for making the restraint net 2 is made up of several strands of material and weaving is achieved by passing a first rope 4a in between the strands of a second rope 4b and then bending each of the first rope 4a and second rope 4b at approximately a right angle.

The previous description of the disclosed embodiments is provided to enable any person skilled in the art to make or use the present disclosure. Various modifications to those embodiments will be readily apparent to those skilled in the art, and the generic principles defined herein may be applied to other embodiments without departing from the spirit or scope of the disclosure. Thus, the present disclosure is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A restraint net for use in restraining a tight grouping of flowline elements where restraint lines are unusable, said restraint net comprising:
a. a net body woven of one or more restraining ropes; and
b. a net perimeter comprising one or more restraining ropes, surrounding the net body,
said restraint net being configured to cover the tight grouping of flowline elements and being of sufficient tensile strength to restrain movement of the flowline elements in case of a failure or separation of the flowline elements in the tight grouping.

2. The restraint net of claim 1 wherein the net perimeter comprises one or more connecting mechanisms for connecting said restraint net to any one or more of one or more restraint lines, one or more further restraint nets or one or more anchoring devices.

3. The restraint net of claim 2, wherein said connecting mechanisms are selected from the group consisting of hooks, loops, tethers or extra rope extending from the perimeter,

4. The restraint net of claim 2, wherein the connecting mechanisms comprise one or more external connecting pieces including shackles and clevises.

6. The restraint net of claim 1, wherein the restraint net body comprises a weave structure selected from the group consisting of a knotless weave structure, a knotted weave structure, a braided weave structure and a stitched weave structure.

7. The restraint net of claim 1 wherein the net perimeter has a thickness that is greater than a thickness of the restraining ropes used to weave the net body.

8. A method of restraining a tight grouping of flowline elements where restraint lines are unusable, said method comprising the steps of:
a. providing the restraint net of claim 1;
b. coupling a first point of the net perimeter to any one or more of an anchoring device, an adjacent restraint net or an adjacent restraint line;
b. extending the net body over the tight grouping of flowline elements; and
c. securing one or more further points of the net perimeter to one or more further anchoring devices, one or more further restraint nets, or one or more further adjacent restraint lines;
whereby, upon a failure or separation of the flowline elements, the restraining net restrains movement of the flowline elements.

9. A restraint net for use in restraining a flowline network of non-tight flowlines and tight groupings of flowline elements, said restraint net comprising:
a. a net body woven of one or more restraining ropes; and
b. a net perimeter comprising one or more restraining ropes, surrounding the net body,
said restraint net being configured to cover the flowline network of non-tight flowline elements and tight grouping of flowline elements, and being of sufficient tensile strength to restrain movement of flowline elements in case of a failure or separation of the flowline elements.

10. The restraint net of claim 9, wherein the restraint net is used in conjunction with and connected to any one or more of one or more further restraint nets, one or more restraint lines or one or more anchoring devices.
